(19) United States
(12) Patent Application Publication
(10) Pub. No.: US 2026/0112653 A1
(43) Pub. Date: Apr. 23, 2026

(54) CURRENT COLLECTOR AND BATTERY

(71) Applicant: TOYOTA JIDOSHA KABUSHIKI KAISHA, Toyota-shi (JP)

(72) Inventors: Tetsuya MIMURA, Chiryu-shi (JP); Atsushi SUGIHARA, Toyota-shi (JP); Satoshi MORIYAMA, Nagoya-shi, (JP); Masayoshi HAGA, Nagoya-shi (JP); Masaki FURUKAWA, Toyota-shi, (JP); Keita YAMASHITA, Nagoya-shi, (JP); Ryuto SAKAMOTO, Okazaki-shi (JP); Hideyuki NAGAI, Nagoya-shi, (JP); Masashi UEDA, Toyota-shi (JP)

(73) Assignee: TOYOTA JIDOSHA KABUSHIKI KAISHA, Toyota-shi (JP)

(21) Appl. No.: 19/254,601

(22) Filed: Jun. 30, 2025

(30) Foreign Application Priority Data
Oct. 22, 2024 (JP) 2024-186120

(51) Int. Cl. H01M 4/66; H01M 50/536

(52) U.S. Cl. CPC H01M 4/667; H01M 50/536

(57) ABSTRACT

A current collector includes a stack and a conductive member. The stack includes a support layer, a first conductive layer, and a second conductive layer. The support layer is made of an electrically insulating resin composition. The conductive member is disposed on the edge of the stack. The conductive member is joined to both the first conductive layer and the second conductive layer.

### CROSS-REFERENCE TO RELATED APPLICATION

This application claims priority to Japanese Patent Application No. 2024-186120 filed on Oct. 22, 2024. The disclosure of the above-identified application, including the specification, drawings, and claims, is incorporated by reference herein in its entirety.

### BACKGROUND

### 1. Technical Field

The present disclosure relates to current collectors and batteries.

### 2. Description of Related Art

Japanese Unexamined Patent Application Publication (Translation of PCT Application) No. 2024-510696 (JP 2024-510696 A) discloses an electrode plate. The electrode plate includes a current collector, an active material layer, and an electrical connection member. The current collector includes a support layer and a conductive layer. In the present specification, the term “conductive” means “electrically conductive” unless specified otherwise. The support layer is made of an electrically insulating material. The conductive layer is disposed on one surface of the support layer. The electrical connection member and the current collector are connected by welding at the edge of the current collector.

### SUMMARY

The current collector may include two or more conductive layers. One possible way to provide a conductive path from one conductive layer to another conductive layer is to first join an electrical connection member (tab) to each of these conductive layers and then join these tabs together. However, such a conductive path from one conductive layer to another conductive layer is relatively long. Therefore, the conductive path increases the electrical resistance of the current collector and easily causes the current collector to generate heat during conduction.

The present disclosure has been made in consideration of the above issue, and its object is to provide a current collector and a battery that can reduce heat generation during conduction.

A current collector according to an aspect of the present disclosure includes a stack and a conductive member. The stack includes a support layer, a first conductive layer, and a second conductive layer. The support layer is made of an electrically insulating resin composition. The conductive member is disposed on the edge of the stack. The conductive member is joined to both the first conductive layer and the second conductive layer.

A battery according to an aspect of the present disclosure includes an electrode assembly and an external terminal. The electrode assembly includes a first electrode, a second electrode, and a separator. The first electrode includes a current collector and an active material layer. The current collector includes a stack and a conductive member. The stack includes a support layer, a first conductive layer, and a second conductive layer. The support layer is made of an electrically insulating resin composition. The conductive member is disposed on the edge of the stack. The conductive member is joined to both the first conductive layer and the second conductive layer. The active material layer is stacked on the first conductive layer. The separator is stacked on the active material layer. The second electrode is stacked on the active material layer with the separator interposed between the second electrode and the active material layer. The external terminal is electrically connected to the first conductive layer.

The present disclosure can reduce heat generation during conduction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view of a battery according to an embodiment;

FIG. 2 is a cross-sectional view of an electrode assembly in FIG. 1, taken along line II-II and viewed in the direction of the arrows;

FIG. 3 is an unwound view of a first electrode according to the embodiment; and

FIG. 4 is a partial cross-sectional view of the first electrode in FIG. 3, taken along line IV-IV and viewed in the direction of the arrows.

### DETAILED DESCRIPTION OF EMBODIMENTS

Hereinafter, a current collector and a battery according to an embodiment of the present disclosure will be described with reference to the drawings. The same or corresponding portions are denoted by the same signs throughout the drawings, and description thereof will not be repeated.

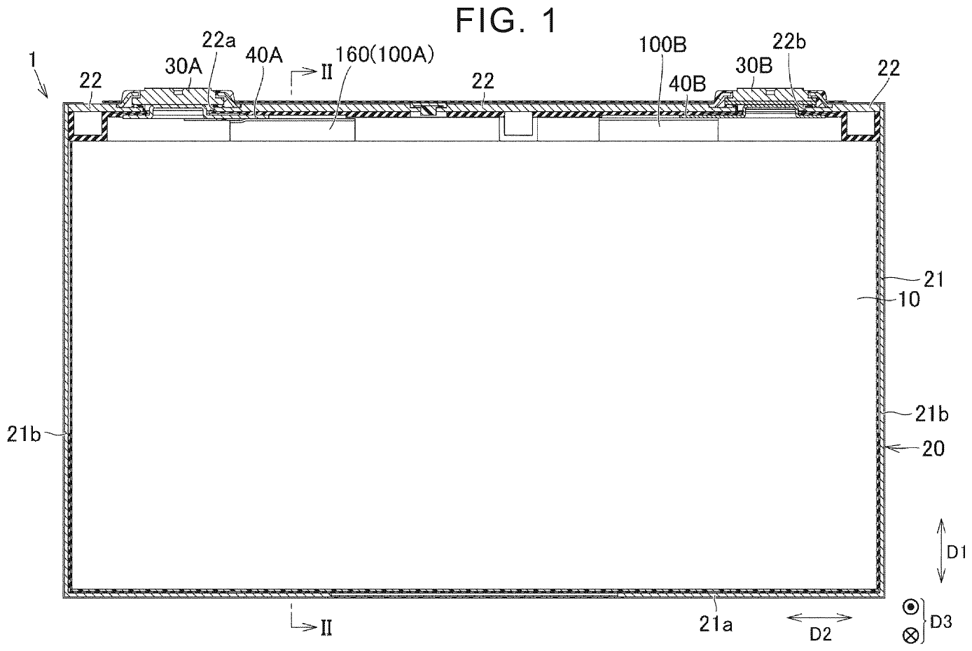

FIG. 1 is a sectional view of the battery according to the embodiment. A battery 1 shown in FIG. 1 is a prismatic battery. The battery 1 may be a secondary battery configured to be charged and discharged such as a lithium-ion battery or a nickel metal hydride battery. The battery 1 can be used, for example, as a cell included in an energy storage module mounted on an electrified vehicle.

As shown in FIG. 1, the battery 1 according to the embodiment of the present disclosure includes an electrode assembly 10, a case 20, a first external terminal 30A, a second external terminal 30B, a first connecting member 40A, and a second connecting member 40B. First, the configuration of the battery 1 other than the electrode assembly 10 will be described.

The case 20 is conductive. A conductive portion of the case 20 is made of a metal such as aluminum. The case 20 houses the electrode assembly 10. The case 20 also contains an electrolyte solution, not shown.

The case 20 includes a case body 21 and a lid 22. The case body 21 includes a bottom wall 21a and a peripheral wall 21b standing from the bottom wall 21a.

The lid 22 is joined to the peripheral wall 21b by welding etc. so as to close an opening of the peripheral wall 21b. The lid 22 has a first connecting hole 22a and a second connecting hole 22b.

The first external terminal 30A and the second external terminal 30B are provided in the battery 1 so as to be exposed to the outside. The first connecting member 40A and the second connecting member 40B are conductive. At least part of the first connecting member 40A and at least part of the second connecting member 40B are disposed inside the case 20.

The first external terminal 30A or the first connecting member 40A is inserted through the first connecting hole 22a. The first external terminal 30A is electrically connected to the first connecting member 40A. Specifically, the first external terminal 30A and the first connecting member 40A are joined together. The first connecting member 40A is joined to the electrode assembly 10. Accordingly, the first external terminal 30A is electrically connected to the electrode assembly 10.

The second external terminal 30B or the second connecting member 40B is inserted through the second connecting hole 22b. The second external terminal 30B is electrically connected to the second connecting member 40B. Specifically, the second external terminal 30B and the second connecting member 40B are joined together. The second connecting member 40B is joined to the electrode assembly 10. Accordingly, the second external terminal 30B is electrically connected to the electrode assembly 10.

In the present embodiment, the first external terminal 30A is a cathode terminal, and the second external terminal 30B is an anode terminal. The first external terminal 30A and the second external terminal 30B are arranged in a second direction D2. The second direction D2 is a direction perpendicular to a first direction D1.

Next, the electrode assembly 10 will be described. The battery 1 according to the present embodiment includes a plurality of the electrode assemblies 10. The battery 1 typically includes two electrode assemblies 10. The electrode assemblies 10 are arranged in a third direction D3. The third direction D3 is a direction perpendicular to both the first direction D1 and the second direction D2.

In the following, one of the electrode assemblies 10 will be described. Each of the electrode assemblies 10 may have the configuration described below.

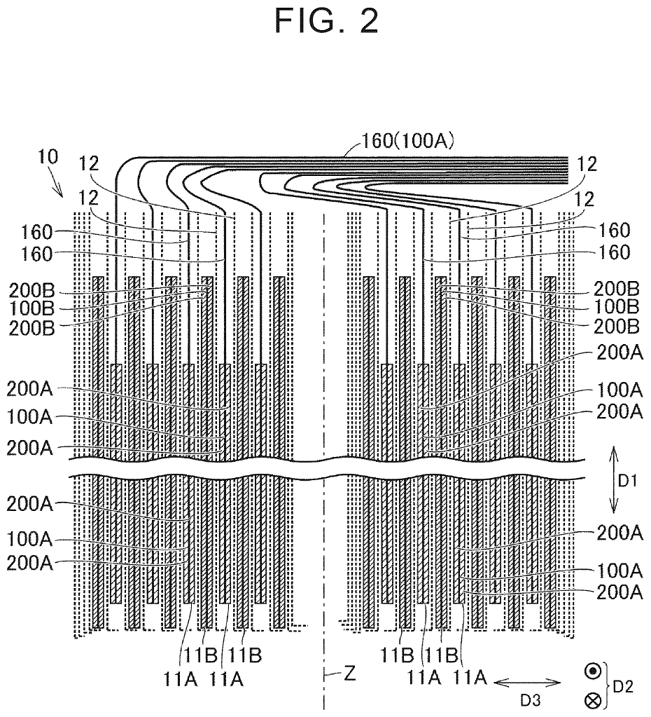

FIG. 2 is a cross-sectional view of the electrode assembly in FIG. 1, taken along line II-II and viewed in the direction of the arrows. As shown in FIGS. 1 and 2, the electrode assembly 10 includes a first electrode 11A, a second electrode 11B, and a separator 12. In the electrode assembly 10, the first electrode 11A, the second electrode 11B, and the separator 12 are wound around a winding axis Z. As described above, in the present embodiment, the electrode assembly 10 is a wound electrode assembly. However, the electrode assembly 10 may be a stacked electrode assembly in which the first electrode 11A, the second electrode 11B, and the separator 12 are stacked in one direction (e.g., the third direction D3). In FIG. 2, the separator 12 is schematically illustrated by dashed lines.

The first electrode 11A and the second electrode 11B have an outer shape in the form of a sheet. The electrode assembly 10 is constituted by an electrode plate group in which the first electrode 11A and the second electrode 11B are wound with one or more separators 12 interposed therebetween. In the present embodiment, the first electrode 11A is a cathode, and the second electrode 11B is an anode. However, the first electrode 11A may be an anode and the second electrode 11B may be a cathode.

The separator 12 is provided between the first electrode 11A and the second electrode 11B. The separator 12 separates the first electrode 11A from the second electrode 11B while allowing ions to travel between the first electrode 11A and the second electrode 11B. The ions are, for example, lithium ions. The separator 12 has electrical insulation properties.

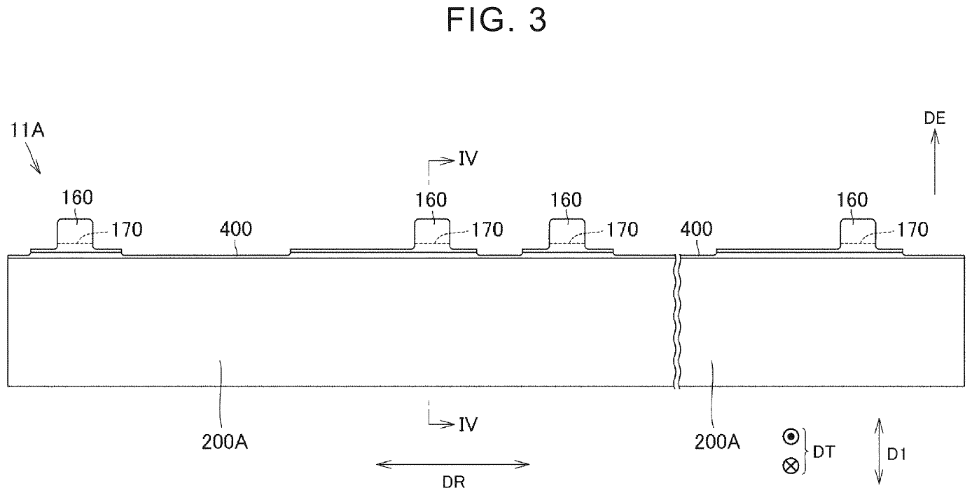

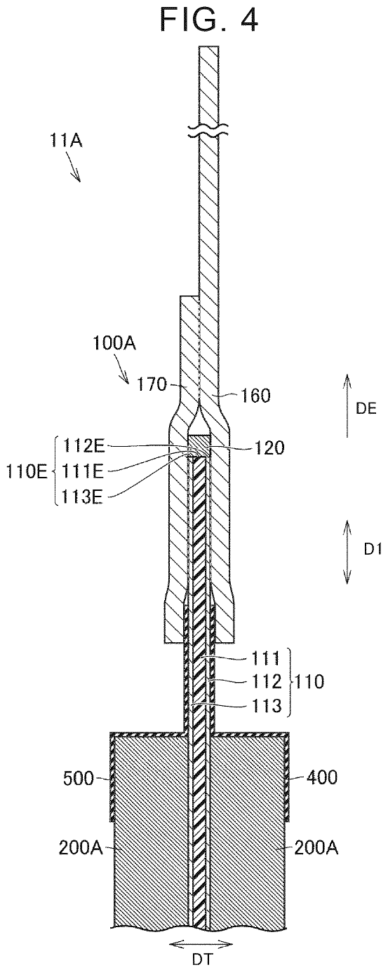

FIG. 3 is an unwound view of the first electrode according to the present embodiment. That is, FIG. 3 illustrates the state before the first electrode 11A is wound. FIG. 4 is a partial cross-sectional view of the first electrode in FIG. 3, taken along line IV-IV and viewed in the direction of the arrows.

As shown in FIGS. 2 to 4, the first electrode 11A includes a first current collector 100A, a pair of first active material layers 200A, a first protective portion 400, and a second protective portion 500.

As shown in FIG. 4, the first current collector 100A includes a stack 110, a conductive member 120, a plurality of first tabs 160, and a plurality of second tabs 170. The stack 110 includes a support layer 111, a first conductive layer 112, and a second conductive layer 113.

The support layer 111 is made of an electrically insulating resin composition. Therefore, the first current collector 100A is a composite current collector constituted by a conductive member and an electrically insulating member. As a result, the first current collector 100A becomes lighter and the overall safety of the battery 1 is improved, compared to when the first current collector 100A is entirely made of metal.

The support layer 111 is made of a material with higher rigidity than the separator 12. The support layer 111 is made of a resin composition containing, for example, a polyamide-based resin, a polyester-based resin, or a polyolefin-based resin. In order to increase rigidity, the support layer 111 is preferably made of a resin composition containing a polyester-based resin. More preferably, the support layer 111 is substantially made of a polyester-based resin. The polyester-based resin may be, for example, polyethylene terephthalate (PET). This can increase the rigidity of the first current collector 100A while maintaining the electrical insulation properties of the support layer 111. Moreover, the support layer 111 can be made relatively thin.

A thickness direction DT of the support layer 111 is substantially perpendicular to the first direction D1. That is, the support layer 111 extends in the first direction D1.

In order to reduce the overall thickness of the electrode assembly 10, the thickness of the support layer 111 is, for example, preferably 20 μm or less, more preferably 15 μm or less, and even more preferably 10 μm or less. The overall thickness of the support layer 111 is not particularly limited as long as it has a desired rigidity. The support layer 111 may have any thickness of, for example, 2 μm or more.

The first conductive layer 112 is disposed on one side of the support layer 111 in the thickness direction DT. The first conductive layer 112 is stacked on the support layer 111. The first conductive layer 112 may be stacked on the entire surface of the one side of the support layer 111.

The second conductive layer 113 is disposed on the other side of the support layer 111 in the thickness direction DT. The second conductive layer 113 is stacked on the support layer 111. The second conductive layer 113 may be stacked on the entire surface of the other side of the support layer 111.

The first conductive layer 112 and the second conductive layer 113 are made of a metal. The metal may include aluminum, copper, and nickel. In the present embodiment, the first conductive layer 112 and the second conductive layer 113 are made of a metal containing aluminum. Accordingly, the first current collector 100A including the first conductive layer 112 and the second conductive layer 113 can be suitably used as a cathode current collector. The first conductive layer 112 may be substantially made of aluminum. The first current collector 100A may be an anode current collector.

Each of the first conductive layer 112 and the second conductive layer 113 has a thickness smaller than the thickness of the support layer 111. In order to reduce the overall thickness of the electrode assembly 10, each of the first conductive layer 112 and the second conductive layer 113 has a thickness of, for example, 5 μm or less, more preferably 2 μm or less, and even more preferably 1 μm or less. Each of the first conductive layer 112 and the second conductive layer 113 may have any thickness of, for example, 0.1 μm or more in order to reduce the possibility of the electrical resistance of each of the first conductive layer 112 and the second conductive layer 113 becoming too large. When the thickness of the first conductive layer 112 and the thickness of the second conductive layer 113 are 5 μm or less, it is difficult to directly weld the first conductive layer 112 and the second conductive layer 113 together or to directly join them together by ultrasonic welding.

The method for forming the first conductive layer 112 and the second conductive layer 113 is not particularly limited. Typically, the first conductive layer 112 and the second conductive layer 113 may be provided directly on the support layer 111 by a sputtering method, a vapor deposition method, etc. The first conductive layer 112 and the second conductive layer 113 may be made of a metal film. In this case, the first conductive layer 112 and the second conductive layer 113 may be bonded to the support layer 111 via a resin adhesive.

The conductive member 120 is disposed on an edge 110E of the stack 110. The edge 110E faces one of the directions perpendicular to the thickness direction DT. Specifically, the edge 110E faces one direction of the first direction D1. More specifically, the edge 110E faces an extending direction DE that will be described later.

The conductive member 120 is joined to both the first conductive layer 112 and the second conductive layer 113. The conductive member 120 is also joined to the support layer 111.

The conductive member 120 is joined to both an edge 112E of the first conductive layer 112 and an edge 113E of the second conductive layer 113. The edges 112E, 113E face one of the directions perpendicular to the thickness direction DT. Specifically, the edges 112E, 113E face one direction of the first direction D1. More specifically, the edges 112E, 113E face the extending direction DE that will be described later. The conductive member 120 is also joined to an edge 111E of the support layer 111. The conductive member 120 may be provided on each of the edges 111E, 112E, 113E along the entire length of the stack 110 in a winding direction DR. In the present embodiment, the edge 110E of the stack 110 includes the edges 111E, 112E, 113E.

The material of the conductive member 120 is not particularly limited as long as it is conductive. The conductive member 120 is a conductive resin member, a metal member, or carbon, and is typically a conductive resin member.

Typically, a conductive resin member is formed by curing a conductive resin paste. The conductive resin paste contains a conductive component including metal or carbon, and an electrically insulating resin component. The metal as the conductive component may include, for example, silver (Ag), copper (Cu), or nickel (Ni). The carbon as the conductive component may include, for example, carbon black, graphite, carbon fibers, carbon nanotubes, or graphene flakes.

Examples of the resin component (binder) include, but are not particularly limited to, urethane resins, polyester-based resins, phenoxy resins, polyamide resins, polyamide-imide resins, polyimide resins, polyurethane resins, acrylic resins, polystyrenes, styrene-acrylic resins, styrene-butadiene copolymers, epoxy resins, phenolic resins, polyether-based resins, polycarbonate-based resins, alkyd resins, polysulfone resins, polyether sulfone resins, vinyl chloride-vinyl acetate copolymer resins, ethylene-vinyl acetate copolymers, silicone resins, and fluorine-based resins.

When the conductive member 120 is a conductive resin member, the conductive resin member may be formed by coating the edge 110E of the stack 110 with a conductive paste by dip coating and then curing the conductive paste.

When the conductive member 120 is a metal member, the metal member may include, for example, aluminum (Al), silver (Ag), copper (Cu), or nickel (Ni). The metal member may be provided on the edge 111E of the support layer 111 by, for example, a vapor deposition method. When the conductive member 120 is carbon, the carbon may be provided on the edge 111E by a conventionally known coating method.

The material constituting the conductive member 120 may have a lower Young's modulus than the material constituting the support layer 111. This can reduce the possibility that the conductive member 120 may impair the workability of the first current collector 100A. The workability of the first current collector 100A herein refers to, for example, the ease of winding.

As shown in FIG. 3, the first tabs 160 are arranged in the winding direction DR of the electrode assembly 10. The second tabs 170 are arranged in the winding direction DR of the electrode assembly 10. The first tabs 160 are spaced apart from each other. The second tabs 170 are spaced apart from each other. The second tubs 170 are arranged in a one-to-one correspondence with the first tabs 160 in the thickness direction DT.

As shown in FIG. 2, the first tabs 160 are arranged in the third direction D3. The first tabs 160 are joined together by ultrasonic bonding etc. As shown in FIG. 1, the first tabs 160 are also joined to the first connecting member 40A by ultrasonic bonding etc. Accordingly, the first external terminal 30A is electrically connected to the first tabs 160. Furthermore, the first external terminal 30A is electrically connected to the first conductive layer 112 and the second conductive layer 113. The configuration of each of the first tabs 160 and the configuration of each of the second tabs 170 will be described below.

The first tab 160 is joined to the opposite surface of the first conductive layer 112 from the support layer 111 by ultrasonic welding. The first tab 160 is partially joined to the first conductive layer 112. The first tab 160 extends substantially along the first direction D1 on the first conductive layer 112. The first tab 160 extends away from the first conductive layer 112. The extending direction DE, namely a direction in which the first tab 160 extends, is substantially parallel to the first direction D1. The first tab 160 may be directly joined to the first external terminal 30A. The first tab 160 is in contact with the conductive member 120 in the thickness direction DT.

The second tab 170 is joined to the opposite surface of the second conductive layer 113 from the support layer 111 by ultrasonic welding. The second tab 170 is partially joined to the second conductive layer 113. The second tab 170 extends substantially along the first direction D1 on the second conductive layer 113. The second tab 170 extends away from the second conductive layer 113 along the extending direction DE. An end of the second tub 170 in the extending direction DE is joined to the first tab 160 by ultrasonic bonding. The extending length of the second tab 170 is shorter than the extending length of the first tab 160. The second tab 170 is in contact with the conductive member 120 in the thickness direction DT.

The first tab 160 and the second tab 170 are members in the form of a film. The first tab 160 and the second tab 170 are typically made of a metal film including, for example, aluminum or copper.

Each of the first tab 160 and the second tab 170 has a thickness greater than the thicknesses of the first conductive layer 112 and the second conductive layer 113. Each of the first tab 160 and the second tab 170 has a thickness of, for example, preferably 20 μm or less, more preferably 15 μm or less, and even more preferably 10 μm or less. The thicknesses of the first tab 160 and the second tab 170 are not particularly limited as long as they have a desired rigidity. Each of the first tab 160 and the second tab 170 may have any thickness of, for example, 2 μm or more.

One of the first active material layers 200A is partially stacked on the first conductive layer 112. The other first active material layer 200A is partially stacked on the second conductive layer 113. The first active material layers 200A are cathode active material layers. However, the first active material layers 200A may be anode active material layers. The first active material layers 200A are spaced apart from the first tab 160 and the second tab 170. The separator 12 is stacked on the first active material layer 200A in a radial direction about the winding axis Z.

The first protective portion 400 is made of an electrically insulating ceramic material. The first protective portion 400 covers part of the first active material layer 200A stacked on the first conductive layer 112 on the extending direction DE side. The first protective portion 400 covers the entire surface of the first conductive layer 112 between the first active material layer 200A and the first tab 160. The first protective portion 400 is also partially disposed between the first conductive layer 112 and the first tab 160 in the thickness direction DT.

The second protective portion 500 is made of an electrically insulating ceramic material. The second protective portion 500 covers part of the first active material layer 200A stacked on the second conductive layer 113 on the extending direction DE side. The second protective portion 500 covers the entire surface of the second conductive layer 113 between the first active material layer 200A and the second tab 170. The second protective portion 500 is also partially disposed between the second conductive layer 113 and the second tab 170 in the thickness direction DT.

As shown in FIG. 2, the second electrode 11B is stacked on the first active material layer 200A in the radial direction with the separator 12 interposed therebetween. In the present embodiment, the electrode assembly 10 includes a plurality of separators 12. However, the electrode assembly 10 may include a single separator 12.

The second electrode 11B includes a second current collector 100B and a second active material layer 200B. The second current collector 100B is extended from between the second active material layers 200B toward one side in the first direction D1. The second current collector 100B is joined to the second connecting member 40B by ultrasonic welding (see FIG. 1).

The second current collector 100B is made of, for example, a metal film. The second current collector 100B is made of, for example, a metal including copper. Accordingly, the second current collector 100B can be suitably used as an anode current collector. When the first current collector 100A is an anode current collector and the second current collector 100B is a cathode current collector, the second current collector 100B may be made of a metal including aluminum. The second current collector 100B may have the same configuration as the first current collector 100A.

The second active material layer 200B is stacked on both sides of the second current collector 100B. In the present embodiment, the second electrode 11B is an anode. Therefore, the second active material layers 200B are anode active material layers. However, the second active material layers 200B may be cathode active material layers.

As described above, the first current collector 100A according to the embodiment of the present disclosure includes the stack 110 and the conductive member 120. The stack 110 includes the support layer 111, the first conductive layer 112, and the second conductive layer 113. The support layer 111 is made of an electrically insulating resin composition. The conductive member 120 is disposed on the edge 110E of the stack 110. The conductive member 120 is joined to both the first conductive layer 112 and the second conductive layer 113.

With the above configuration, the first conductive layer 112 and the second conductive layer 113 can be electrically connected to each other via the conductive member 120 disposed on the edge 110E of the stack 110, rather than via the tabs stacked on the surfaces of the first conductive layer 112 and the second conductive layer 113. Therefore, the conductive path between the first conductive layer 112 and the second conductive layer 113 becomes relatively short. As a result, the electrical resistance value in the conductive path becomes relatively small, which can reduce heat generation during conduction in the first current collector 100A.

In the present embodiment, the first conductive layer 112 is disposed on one side of the support layer 111 in the thickness direction DT. The second conductive layer 113 is disposed on the other side of the support layer 111 in the thickness direction DT. The conductive member 120 is joined to both the edge 112E of the first conductive layer 112 and the edge 113E of the second conductive layer 113.

With the above configuration, the conductive path between the first conductive layer 112 and the second conductive layer 113 is further shortened. As a result, the electrical resistance value in the conductive path is further reduced, which can further reduce heat generation during conduction in the first current collector 100A.

The first current collector 100A according to the present embodiment further includes the first tab 160 and the second tab 170. The first tab 160 is joined to the surface of the first conductive layer 112 by ultrasonic welding. The first tab 160 is in contact with the conductive member 120. The second tab 170 is joined to the surface of the second conductive layer 113 by ultrasonic welding. The second tab 170 is joined to the first tab 160 by ultrasonic welding. The second tab 170 is in contact with the conductive member 120.

With the above configuration, in the conductive path between the first conductive layer 112 and the second conductive layer 113, the cross-sectional area of the entire conductor, perpendicular to the conductive path, is increased. As a result, the electrical resistance value in the conductive path between the first conductive layer 112 and the second conductive layer 113 is even more reduced. This can even more reduce heat generation during conduction in the first current collector 100A.

In the present embodiment, the conductive member 120 is a conductive resin member. The conductive resin member is formed by curing a conductive resin paste. The conductive resin paste contains a conductive component including metal or carbon, and an electrically insulating resin component.

With the above configuration, the conductive resin member may soften due to the heat generated during the ultrasonic welding of the first tab 160 and the second tab 170. This reduces the possibility that the ultrasonic welding of the first tab 160 and the second tab 170 may be hindered. As a result, separation of the first tab 160 and the second tab 170 can be reduced. Moreover, the conductive resin member can be more securely connected to the first tab 160 and the second tab 170.

In the above description of the embodiment, configurations that can be combined may be combined with each other.

The embodiment disclosed herein should be considered to be illustrative in all respects and not restrictive. The scope of the present disclosure is set forth by the claims rather than by the above description, and is intended to include all modifications within the meaning and scope equivalent to the claims.

What is claimed is:

1. A current collector comprising:
a stack; and
a conductive member, wherein:
the stack includes a support layer, a first conductive layer, and a second conductive layer;
the support layer is made of an electrically insulating resin composition;
the conductive member is disposed on an edge of the stack; and
the conductive member is joined to both the first conductive layer and the second conductive layer.

2. The current collector according to claim 1, wherein:
the first conductive layer is disposed on one side of the support layer in a thickness direction;
the second conductive layer is disposed on the other side of the support layer in the thickness direction; and
the conductive member is joined to both an edge of the first conductive layer and an edge of the second conductive layer.

3. The current collector according to claim 2, further comprising:
a first tab; and
a second tab, wherein:
the first tab is joined to a surface of the first conductive layer by ultrasonic welding;
the first tab is in contact with the conductive member;
the second tab is joined to a surface of the second conductive layer by the ultrasonic welding;
the second tab is joined to the first tab by the ultrasonic welding; and
the second tab is in contact with the conductive member.

4. The current collector according to claim 3, wherein the conductive member is a conductive resin member, the conductive resin member being made of a cured conductive resin paste and containing a conductive component including metal or carbon, and an electrically insulating resin component.

5. A battery comprising:
an electrode assembly; and
an external terminal, wherein:
the electrode assembly includes a first electrode, a second electrode, and a separator;
the first electrode includes a current collector and an active material layer;
the current collector includes a stack and a conductive member;
the stack includes a support layer, a first conductive layer, and a second conductive layer;
the support layer is made of an electrically insulating resin composition;
the conductive member is disposed on an edge of the stack;
the conductive member is joined to both the first conductive layer and the second conductive layer;
the active material layer is stacked on the first conductive layer;
the separator is stacked on the active material layer;
the second electrode is stacked on the active material layer with the separator interposed between the second electrode and the active material layer; and
the external terminal is electrically connected to the first conductive layer.
